(19) United States
(12) Patent Application Publication
(10) Pub. No.: US 2003/0093384 A1
(43) Pub. Date: May 15, 2003

(54) Scanner enhanced remote control unit and system for automatically linking to on-line resources

(76) Inventors: Robert T. Durst JR., Fort Myers, FL (US); Kevin D. Hunter, Fort Myers, FL (US)

Correspondence Address: Anthony R. Barkume, Esq., 20 Gateway Lane, Manorville, NY, 11949, US

(21) Appl. No.: 10/138,928

(22) Filed: May 3, 2002

Related U.S. Application Data
(63) Continuation of application No. 09/074,230, filed on May 7, 1998, now abandoned.
Application No. 09/074,230 is a continuation-in-part of application No. 08/967,383, filed on Nov. 8, 1997, now Pat. No. 5,933,829.
Application No. 09/074,230 is a continuation-in-part of application No. 09/023,918, filed on Feb. 13, 1998, now abandoned.
(60) Provisional application No. 60/045,830, filed on May 7, 1997.

(51) Int. Cl. G06F 17/60

(52) U.S. Cl. 705/64

(57) ABSTRACT

A method for providing remote access to on-line resources comprising the steps of encoding address and access information and optional source identification information into a format suitable for embedding onto a document, the format comprising one or two-dimensional bar codes or printed matter, embedding the encoded information onto a document, scanning the document with a scanner enhanced remote control unit comprising a scanning system adapted to obtain an image of the embedded information and a transmission system adapted to transmit the scanned information, transmitting the scanned information, receiving the transmitted information, optionally processing the received information, optionally collecting the user demographic and source identification information, retrieving the on-line resource, and displaying the on-line resource to a user. Also an apparatus which provides remote access to on-line resources comprising an encoder of address and access information and optional source identification information into a format suitable for embedding onto a document, an embedding system, a scanner enhanced remote control unit comprising a scanning system adapted to obtain an image of the embedded information and a transmission system, a transmitter which transmits the scanned information, a receiver which receives the transmitted information, an optional processor of the received information, an optional collector of the user demographic and source identification information, a retrieving system, and a display system.

### CROSS-REFERENCE TO RELATED APPLICATIONS

This application is a continuation-in-part application of co-pending U.S. application Ser. No. 08/967,383, filed Nov. 8, 1997; and is a continuation-in-part application of co-pending U.S. application Ser. No. 09/023,918, filed on Feb. 13, 1998; and claims priority of co-pending U.S. provisional application serial No. 60/045,830, filed on May 7, 1997; all of which are assigned to the assignee of the present application and incorporated by reference herein.

### BACKGROUND OF THE INVENTION

Electronic data sources, such as the Internet and the World Wide Web (WWW) are a rich and important means of information retrieval and distribution and, increasingly, electronic commerce. However, there are problems finding and accessing the information desired in this increasingly complex and dynamic network of resources. Recently introduced Internet “search engines”, such as Yahoo, help by allowing a user to search on-line indices of information sources, and even full source text, for relevant key words and phrases related to their topic of interest, but even carefully structured queries by experienced users often results in hundreds and even thousands of possible “hits” which are not sufficiently specific to preclude further manual search which is both data resource inefficient and time consuming.

Because of these inefficiencies, as well as general lack of familiarity with search engines and their syntax, users sometimes rely on printed media to identify source addresses (e.g., Uniform Resource Locators (“URL's”)) for web sites and other on-line information of interest.

However, URL's, are particularly difficult to manually enter in software programs, such as browsers, due to their length and use of complex and unfamiliar symbols. If the characters in an address are not entered exactly, retrieval is prevented or, in a limited number of cases, a legal but incorrect source is accessed. This is especially true when URL's incorporate foreign languages and/or complex query instructions to on-line databases, as is increasingly frequent in most web sites. In addition, the inability to type or otherwise manually enter symbolic address information due to either disability or lack of training complicates use of on-line information resources such as the Internet and World Wide Web for millions of individuals.

It is widely anticipated that Internet and WWW access will increasingly be provided through interactive cable television via web-ready television receivers and set-top conversion units in conjunction with conventional television receivers. Web-ready television is a television that can receive and display conventional broadcast television signals, which also has computer means for allowing a user to access the Internet by providing a modem and appropriately programmed microprocessor based control circuitry. A software module such as a web browser is used by the computer means to allow the user to dial-up an Internet service provider (ISP) and request files from host servers on the Internet. The downloaded Web pages may be displayed via the browser on the entire screen or on a portion of the TV screen (i.e. via picture-in-picture (PIP)). Thus, the user can both watch TV and “surf the Web”, as independent functions, with one piece of equipment. A set-top converter is similar in functionality and is used in conjunction with a conventional TV to accomplish the same effect; for example, SONY markets such a device as a “WebTV” product. In a home entertainment environment, it is difficult to use keyboards for address entry due to both a lack of typing skill and the cumbersome placement of these components.

Therefore, a method which would eliminate typing and allow users to directly link printed media options to on-line resources by simply scanning them while watching television would be highly desirable.

Another problem which is prevalent is the lack of information available to on-line resource providers regarding the users who access their on-line resources and the origin of the address and access information used to link to their online resource. Often a potential user must undergo a lengthy and perhaps intrusive, interactive question and answer process in order to be authorized for access to a particular on-line resource. In today's world of limited time and unlimited options it becomes increasingly likely that a potential user will either hastily enter the first answer which comes to the imagination or which appears on the questionnaire or even bypass the site entirely. Naturally, neither of these responses is particularly accurate nor useful to the on-line resource provider.

Therefore, a method which would provide demographic information regarding the user as well as identification information regarding the particular printed document in which the address and access information to link to the on-line resource was found would be of great value to the on-line resource provider. That is, it would be useful for the identity of a user viewing a television show and who scans a bar code symbol from a printed document related to that show (e.g. from a broadcast schedule book) to be made known in an automatic fashion to the linked web site for future advertising analysis purposes.

Therefore, there is a need for an efficient automatic link between printed media and on-line resources which is user friendly to the majority of potential users in order to satisfy both commercial and informational enterprises. In particular, there is a need to incorporate the automatic linking of online resources to printed media in the context of the normal viewing habits of broadcast television viewers.

### SUMMARY OF THE INVENTION

The present invention is a combination television remote control and optical (i.e. bar code) scanner comprising a housing; optical scanning means within the housing for scanning a machine-readable symbol printed on a document and producing an electrical signal indicative of the machine-readable signal, the machine-readable symbol being encoded with data representative of a location of a networked resource such as a data file to be accessed by a networked computer means associated with the apparatus; means within the housing for processing the electrical signal to produce address information useful in accessing the data file; means within the housing for transmitting the address information to a remotely located computer means; and means within the housing for remotely controlling a television means associated with the computer means.

In further accordance with the present invention a method is provided for remote access to on-line resources comprising the steps of encoding address and access information, and optional source identification information into a format suitable for embedding onto a document, the format comprising one or two-dimensional bar codes or conventional printed characters, embedding the encoded information onto a document, scanning the document with a scanner enhanced remote control unit comprising a scanning system adapted to obtain an image of the embedded information and a transmission system adapted to transmit the scanned information to a computer means, transmitting the scanned information to the computer means, receiving the transmitted information by the computer means, optionally processing the received information, optionally collecting the user demographic and source identification information, retrieving the on-line resource correlated to the address information, and displaying the on-line resource to a user on the television screen.

In further accordance with the present invention an apparatus is provided which comprises remote access to on-line resources comprising an encoder of address and access information and optional source identification information into a format suitable for embedding onto a document, an embedding system for rendering the document including the encoded information, a scanner enhanced remote control unit comprising a scanning system adapted to obtain an image of the embedded information, a transmitter which transmits the scanned information to a computer means, a receiver associated with the computer means which receives the transmitted information, an optional processor of the received information, an optional collector of the user demographic and source identification information, a resource retrieval system, and a resource display system.

### BRIEF DESCRIPTION OF THE DRAWINGS

FIG. 1A illustrates scanning of machine readable symbol on a printed document by a first embodiment of a scanner enhanced remote control unit of the present invention using a scanning system discrete from the transmission system used to transmit scanned and other information to a web-ready television or set-top conversion unit.

FIG. 1B illustrates scanning of machine readable symbol on the printed document by a second embodiment of the scanner enhanced remote control unit of the present invention using a scanning system that is integral with the transmission system used to transmit scanned information to the web-ready television or set-top conversion unit.

FIG. 1C illustrates transmission of scanned data of the machine readable symbol by either of the embodiments of the scanner enhanced remote control unit of FIG. 1A or 1B to the web-ready television or set-top conversion unit.

FIG. 2A illustrates scanning of a printed document by a third embodiment of the scanner enhanced remote control unit of the present invention using optical character recognition.

FIG. 2B illustrates transmission of scanned data of the printed document by the scanner enhanced remote control unit of FIG. 2A to a personal computer adapted for access to on-line resources.

FIG. 3 illustrates a block diagram of the third embodiment of the scanner enhanced remote control unit of FIG. 2A.

FIG. 4A illustrates a one-dimensional bar code of the prior art.

FIG. 4B illustrates a two-dimensional bar code of the prior art.

FIG. 5 illustrates two sets of stylized fonts of the prior art designed to make optical character recognition less prone to errors.

FIG. 6 illustrates a flowchart for a method of linking to on-line data resources with a scanner enhanced remote control unit.

FIG. 7 illustrates an alternative embodiment flowchart for a method of linking to on-line data resources with a scanner enhanced remote control unit.

FIG. 8 is a detailed block diagram of the system of the present invention.

FIG. 9 is a diagram of the document generation function of FIG. 8.

FIG. 10 is a diagram of the user's computer functions of FIG. 8.

FIG. 11 is a diagram of the de-obfuscating function carried out by the user's computer means of FIG. 10.

FIG. 12 is a diagram of the target server computer of FIG. 8.

FIG. 13 is a top level flowchart of the method of the present invention embodied in FIG. 8.

FIG. 14 is a flowchart of the document generation of the present invention embodied in FIG. 8.

FIGS. 15 and 16 are a flowchart of the scanning and processing by the user's computer means of the present invention.

FIG. 17 is a flowchart of method used by the target server computer of the present invention.

FIG. 18 is a flowchart illustrating the method of another embodiment of the present invention.

FIG. 19 is an illustration of the data format for encoding into a bar code for FIG. 18.

### DETAILED DESCRIPTION OF THE INVENTION

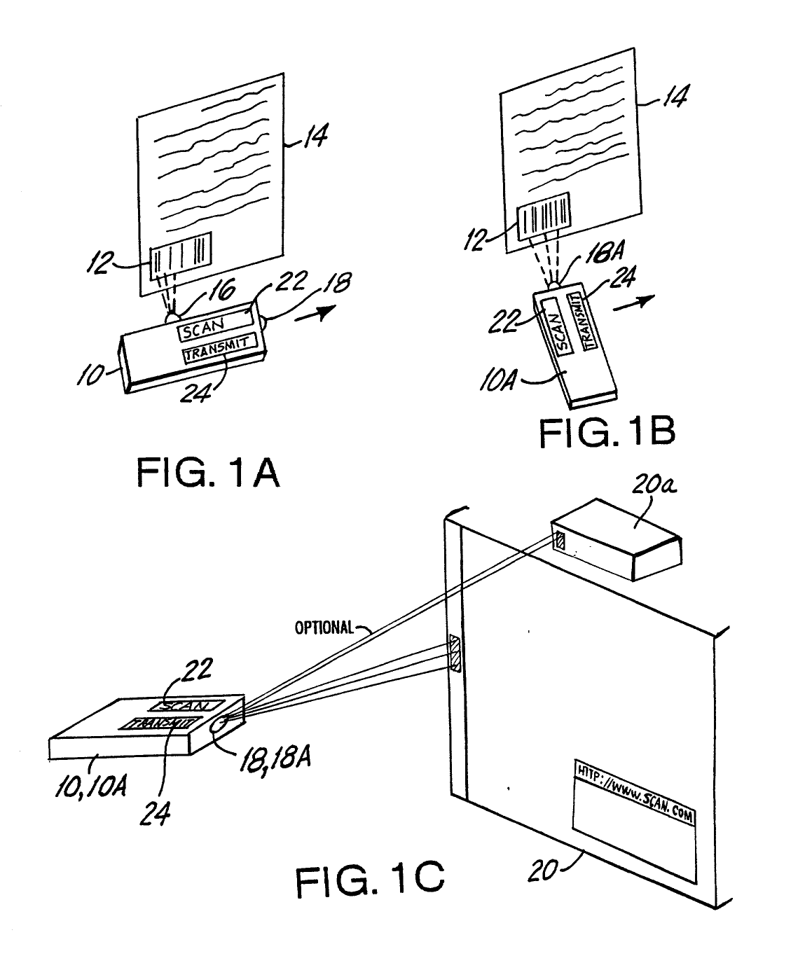

FIG. 1A illustrates a first embodiment of a scanner enhanced remote control unit 10 of the present invention which is shown scanning a machine readable symbol 12 which has been incorporated onto the face of a printed intelligent document 14. The machine readable symbol may comprise linear barcodes, two dimensional barcodes or other suitable codes which can readily be scanned by various optical scanners well known in the art.

The bar code symbol 12 is encoded with data representative of a location of a resource such as a data file to be accessed from a computer network such as the Internet (to be explained in detail below). Thus, the bar code symbol 12 may be encoded with an Internet URL (Uniform Resource Locator) such as “http://www.sports.com”. This will be used by a software program such as a browser to retrieve the file located at that Internet address. In this manner, print media may be encoded to allow a user to easily and automatically access, by scanning to be described herein, an on-line data resource. Thus, a user sitting at home and watching a television show on a “web-ready” television (i.e. a television additionally comprising Internet access means such as a modem, cable modem or the like) may be able to scan with the remote control unit a bar code related to that show, and the web-ready television will be caused to retrieve a data file whose content is related to the show.

The scanner enhanced remote control unit 10 comprises typical television remote control functions (volume, channel, power, etc.) in addition to housing a bar code scanning system. In the first embodiment, a scanning system 16 is distinct from the conventional data transmission system 18 that is used to transmit information to a television.

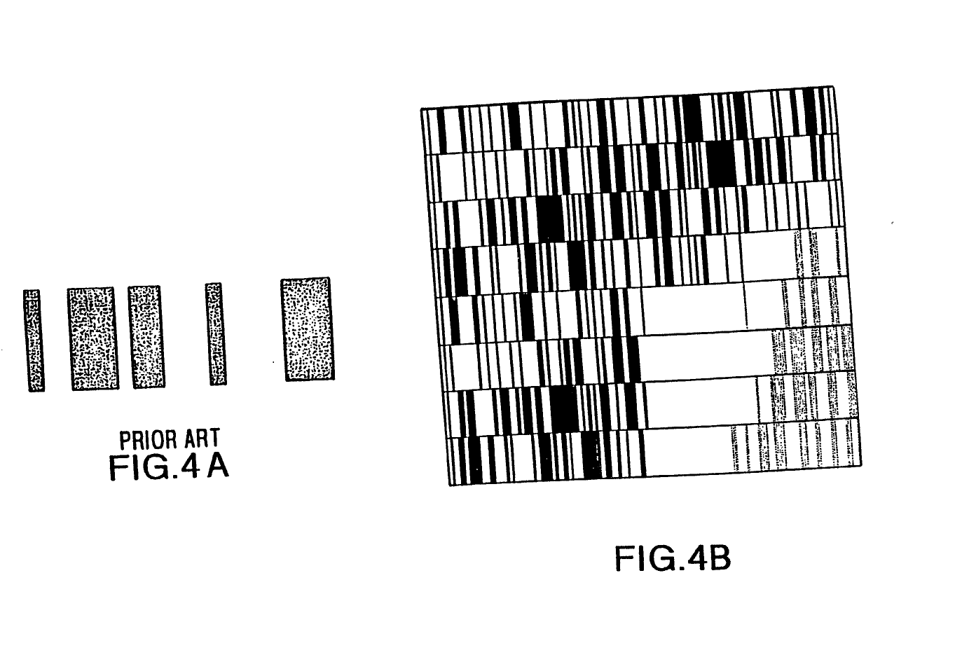

Variants of the first embodiment are achieved by substitution of alternative technologies for the scanning system 16. In a first variant the scanning system 16 is comprised of a one-dimensional laser scanner which is capable of scanning one-dimensional (linear) bar codes such as that shown in FIG. 4A. Such linear bar code laser scanning systems are well known in the art and may comprise a Visible Laser Diode (VLD) which is incident on a scanning mirror. The scanning mirror is caused to oscillate, thus causing the laser beam to sweep across a target bar code. The laser beam is reflected off the target bar code onto a photosensitive transducer, which generates a data signal whose amplitude varies in time as a function of the bars and spaces swept across by the scanner. In a second variant the scanning system 16 is comprised of a two dimensional or rasterizing laser capable of scanning both one-dimensional and two-dimensional bar codes such as that shown in FIG. 4B. Likewise, such rasterizing laser scanners are well known in the art, and are similar to linear scanners except that the mirror oscillates in both the X and Y planes which causes the laser beam to sweep in a raster pattern. In a third variant the scanning system 16 comprises a Light Emitting Diode (LED) wand which can physically be swept by the user across one-dimensional bar codes. In a fourth variant the scanning system 16 comprises a linear, one-dimensional array of Charge Coupled Devices (CCD) which is capable of electronically scanning both one-dimensional bar codes and two-dimensional bar codes (by manually sweeping the linear CCD array over the bar code). In a fifth variant the scanning system 16 comprises a two-dimensional array of Charge Coupled Devices (CCD) which is capable of electronically scanning both one-dimensional bar codes and two-dimensional bar codes. Obviously each of these variants must be provided with the appropriate control and processing software which is well known to one skilled in the art.

In order to access on-line resources for which address and access information is contained in the machine readable symbol 12 a user will first depress a scan button 22 and pass the scanning system 16 across the machine readable symbol 12. Alternatively, the scanning system 16 may be invoked automatically without the need for depression of the scan button 22 whenever machine readable symbol is encountered by the scanning system 16, using a technique referred to as “triggerless” scanning which is well known in the art.

FIG. 1C illustrates transmission of the captured image or pre-processed data of the machine readable symbol 12 to the web-ready television 20 or television set-top conversion unit 20a by the scanner enhanced remote control unit. Upon depression of a transmit button 24 the image data captured during scanning is transmitted to the web-ready television or television set-top conversion unit by conventional techniques such as infrared (IR) technology, which is well known in the art of television remote control devices. It may be advisable to store less than substantially all of the machine readable symbol 12 scanned if transmission of the stored image begins prior to completion of the scanning process. This technique results in essentially a buffering function which is desirable where the machine readable symbol comprises a great deal of information for which it would not be feasible to store entirely within that quantity and density of memory found within a remote control unit comprising convenient dimensions for the typical user. Alternatively, the process of transmission may be invoked automatically upon successful scanning of the machine readable symbol 12, however, a delay would be required following the process of scanning the machine readable symbol 12 in order to provide the user with an opportunity to point the transmission system of either embodiments of the scanner enhanced remote control unit 10 or 10A in the direction of the web-ready television or television set-top conversion unit.

The transmitted information may be a raw digital data representation of the scanned image of the machine readable symbol, or it may be a fully or partially processed and decoded version of the machine readable symbol, or some form of intermediate data. Naturally, as the degree of processing prior to transmission is increased, the intelligence contained within the scanner enhanced remote control units 10 or 10A, in the form of hardware and software, must increase. However, this intelligence need no longer be resident in the computer means associated with the web-ready television or television set-top conversion unit. Thus, essentially a shift in the line defining the boundaries for locating various processing functions (e.g., decoding the machine-readable symbol, and collating user demographic and publication source information) performed upon the information captured during scanning may be made. Naturally, such a shift can be made to best suit commercial and technological advantages of cost, manufacturing time, space and reliability without exceeding the scope of the invention. For instance, a great deal of processing resources may be located within the scanner enhanced remote control unit 10 or 10A and exercised prior to transmission, however, this may lead to an expensive and cumbersome remote control unit which is prone to failure due to its frequency of use by various age groups of users under severe conditions.

FIG. 1B illustrates a second embodiment of the scanner enhanced remote control unit 10A of the present invention which is also shown scanning machine readable symbol 12 embedded onto the face of the printed document 14. The machine readable symbol may comprise linear barcodes, two dimensional barcodes or other suitable codes. The scanner enhanced remote control unit 10A comprises a combination scanning and data transmission system 18A which incorporates the functions of both the scanning system 16 and the transmission system 18 of the first embodiment of the scanner enhanced remote control unit 10 into one unit which utilizes the same light source and potentially additional resources such as control and amplification circuitry and reflecting functions.

In order to access on-line resources with the second embodiment of the scanner enhanced remote control unit 10A, for which address and access information is contained in the machine readable symbol 12, a user will first depress a scan button 22 and pass the combination scanning and transmission system 18A across the machine readable symbol 12 in order to capture an image of the machine readable symbol 12 within the scanner enhanced remote control unit 10A. Alternatively, the scanning system 16 may be automatically invoked without the need for depression of the scan button 22 whenever machine readable symbol is encountered by the scanning system 16 just as with the first embodiment. After the bar code symbol 12 has been scanned, the data therefrom is transmitted by conventional IR means by the combination system 18A to the IR receiver associated with the web-ready television or set-top converter box.

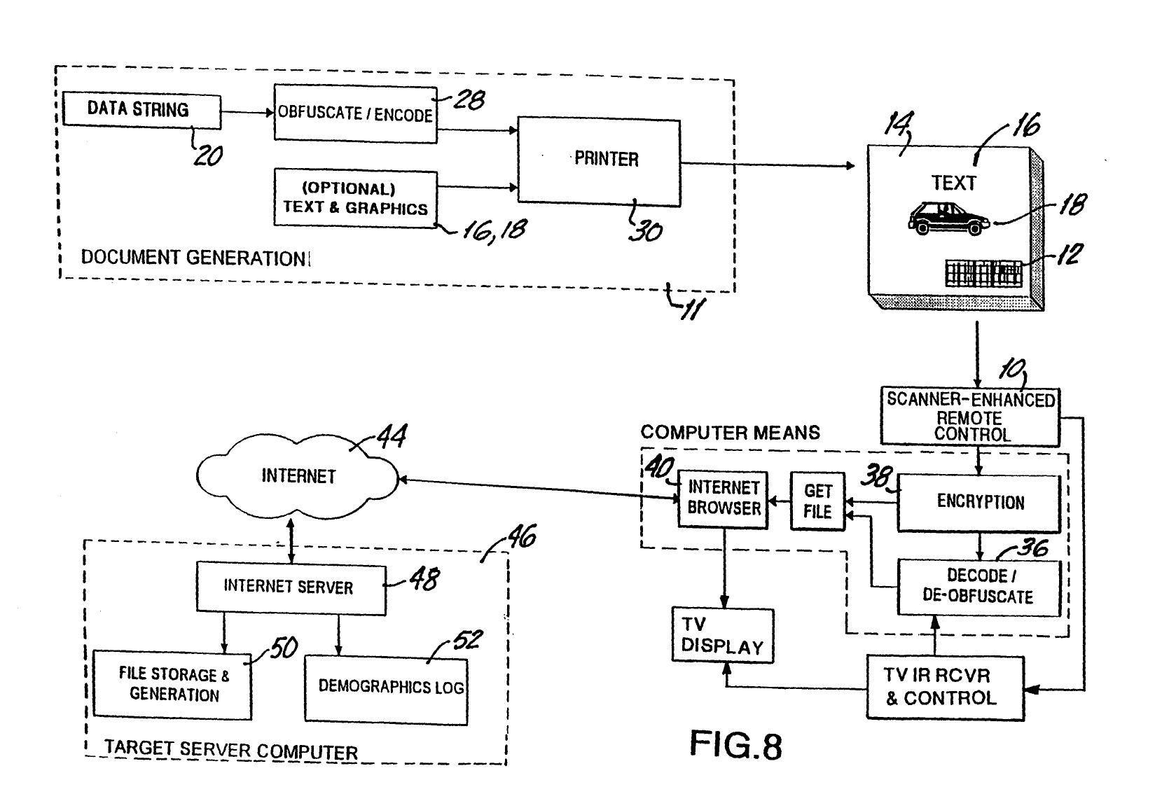

FIG. 8 illustrates a more detailed block diagram of the system of the present invention for generating and reading the intelligent document 14. The system comprises an intelligent document generation system 11, which encodes, assembles and prints an intelligent document 14 for subsequent scanning by the scanner-enhanced remote control unit 10.

The system operates as follows. A vendor who wishes to provide an intelligent document 14 (that will enable a television viewer to automatically link to an Internet resource while viewing a television show) programs certain parameters which will be encoded within a machine-readable code 12 and printed on the document along with text or graphics. The document may be an advertisement in the form of a magazine insert or page, a brochure, or a television schedule book.

Parameters to be included within the machine-readable code depend upon the application desired by the vendor. For example, if the vendor wants the end-user to be able to access the vendor's world wide web (WWW) site automatically upon scanning the code 12, then the parameters included in the machine-readable code may include a command to launch an Internet browser application, such as NETSCAPE, and a uniform resource location (URL) code, such as http://www.xyzcorp.com. This information is encoded in accordance with the particular type of machine code being used. For example, one type of code which may be used by the present invention is a PDF417 symbol, which is described in detail in U.S. Pat. No. 5,304,786, which is incorporated by reference herein. The PDF417 symbol, known as a two-dimensional bar code symbol, has enough storage information to encode the browser launch command as well as the URL.

A printer 30 then utilizes the encoded data and desired text and graphics to print the intelligent document 14 as shown in the Figures.

The intelligent document 14 is disseminated to the end user in accordance with the methods desired by the vendor. For example, if the intelligent document is a television schedule, then the user will obtain the schedule by conventional means such as purchase at a retail outlet, the mail, etc.

The user, after reading the text and graphics in the document, can access the WWW site of the vendor by utilizing the scanner-enhanced remote control unit of the present invention in conjunction with the computer means associated with his web-ready television or set-top converter, programmed with appropriate software in accordance with the invention.

After the bar code data is scanned by the scanner 16 as previously described, a decoder 36 is used to decode the raw data into usable commands and data. The decoder is typically a software program executed by the microprocessor of the computer means or resident on the scanner-enhanced remote control unit, and provides thereby the browser launch command (optionally) and the URL which had been encoded by the vendor into the code. The WWW browser application is then loaded, and the URL is used to access the WWW site of the vendor accordingly. As a result, the user may automatically access the vendor's WWW site without having to enter the URL, thus eliminating all chances of error due to manual data input.

The above scenario is useful when a vendor prints and distributes such intelligent documents such as web-enhanced television schedules on a mass scale. That is, the code distributed is the same for each user. In an alternative embodiment, specific user data is included with the code to provide for personalized operation as follows. This scenario is useful when the vendor makes individual printings keyed to individual users, such as when mailing labels are printed for inclusion on an envelope surrounding a television broadcast schedule or the like.

In this case, the vendor may include in the code personal data such as the user's name, location, phone number, and other appropriate demographic information which may be scanned and held in a temporary buffer for use with subsequent program-related bar code scans. When the user scans the document and loads the WWW site, the personal data from the scanned user-specific bar code is uploaded to the vendor's host computer, thus providing the vendor with useful demographic data as to which users have actually utilized the intelligent document scanning service.

The code may also include security information useful in completing secure transfers across the Internet. For example, an encryption key appropriate in a public or private key system may be embedded within the code. An appropriate software routine in the user's computer utilizes the key after decoding it in order to encrypt certain data being sent across the Internet. For example, the encryption of credit card information is desired in order to thwart would-be intruders from misappropriating the information. The system of the present invention could be used to allow the user to order an item by taking the credit card number, already resident in the user's computer memory, and encrypting it with the key decoded from the code. When the user desires to purchase the item, he scans the associated code, and the credit card number is encoded and transmitted after the WWW site is accessed. The host computer can match the user's name (sent with the transmission) with the appropriate decryption key stored at the host, and decrypt the credit card number accordingly.

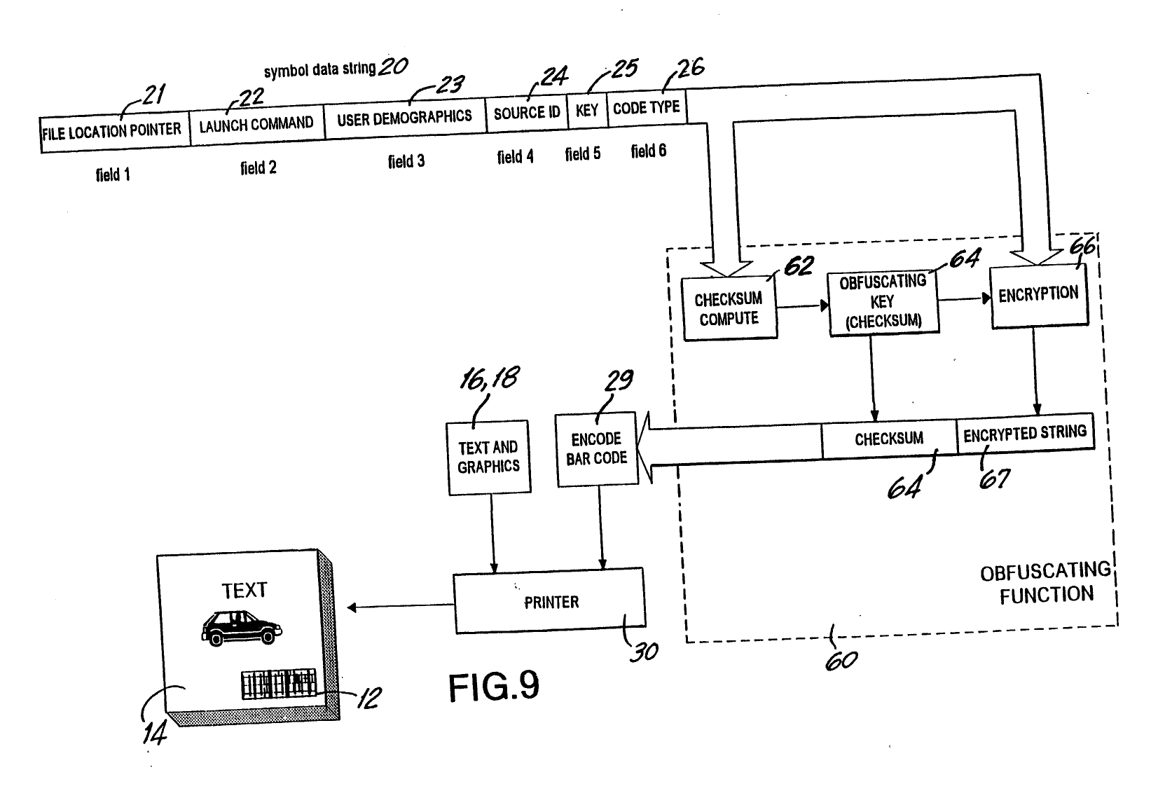

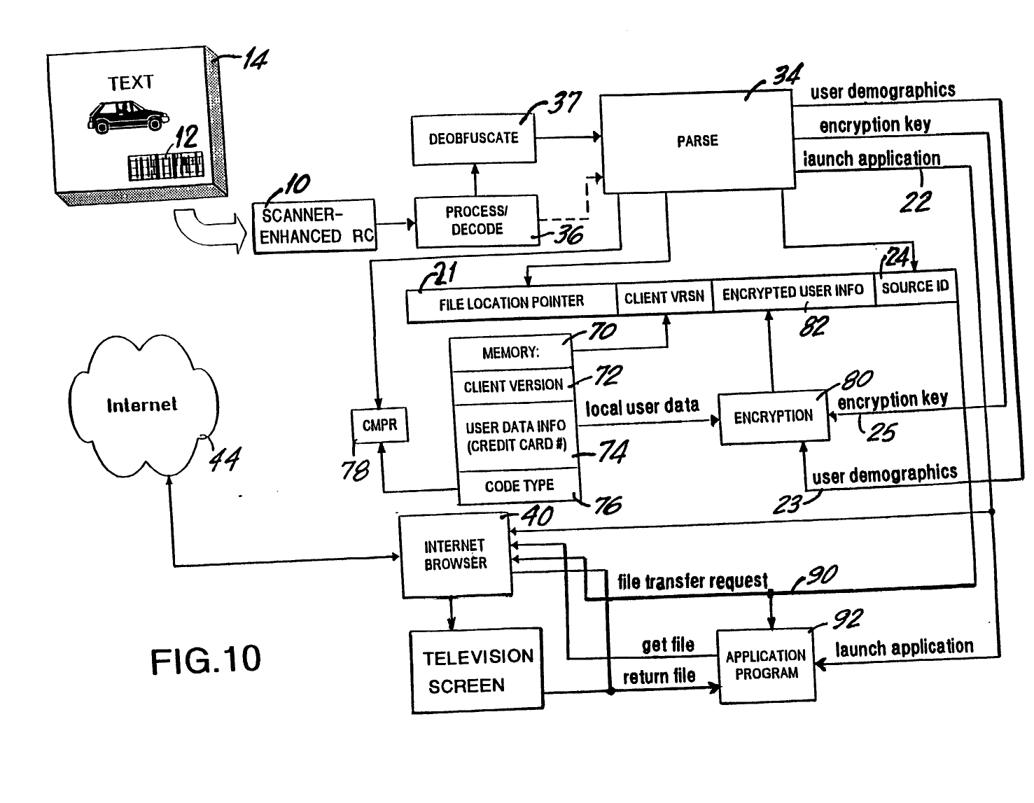

FIG. 9 is an illustration of an obfuscation function of the present invention. Prior to being encoded, the symbol data string may optionally be obfuscated in order to improve the security aspects of the system. The symbol data string is input into a checksum computing means 62, which then computes the checksum of the symbol data string in accordance with teachings well known in the prior art. The computed checksum is then used as a key in an encryption scheme 66 which may be one of several well known encryption methodologies known in the prior art. The key 64 is assembled in the clear (i.e., unencrypted) along with the encrypted symbol data string into by the encoding function 29. After this encrypted data string and cleared checksum data is encoded, it is rendered by the printer 30 in accordance with methods well known in the art and the intelligent document is thereby generated.

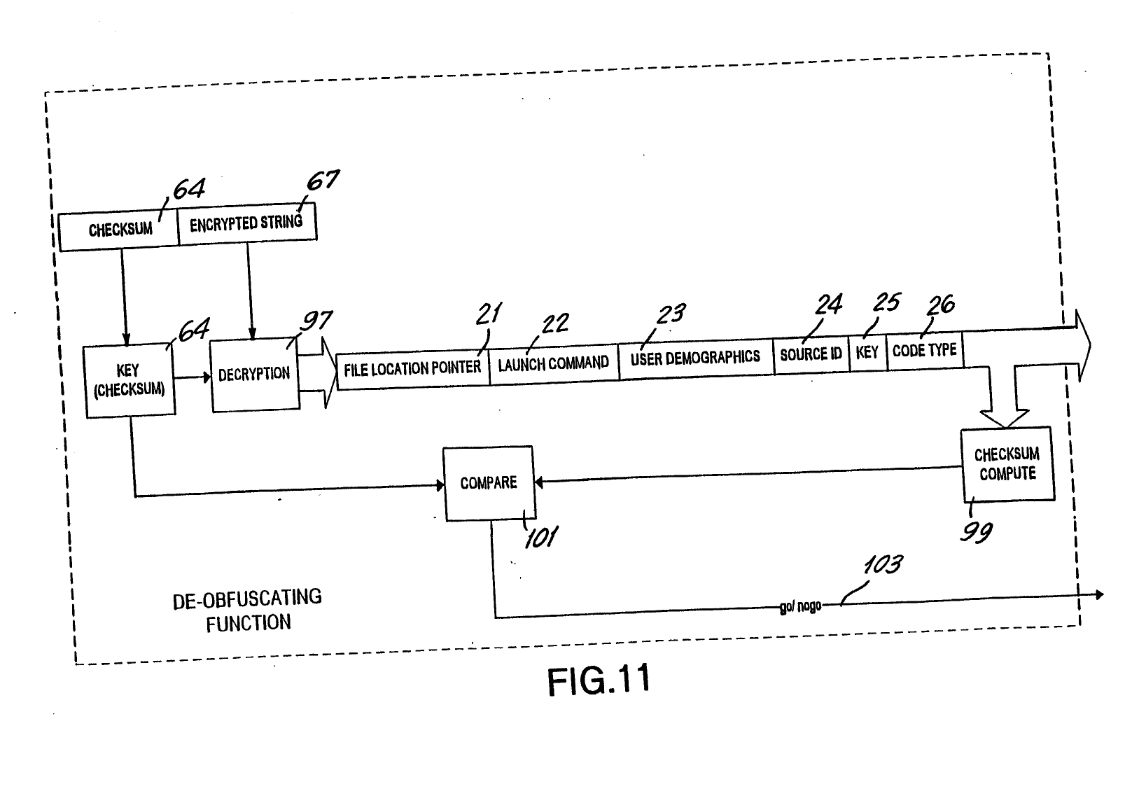

After the intelligent document 14 is distributed to the user, the bar code symbol 12 is scanned by the scanner-enhanced remote control unit and processed as follows. The scanned symbol data is decoded by means well known in the art in accordance with the particular symbology implemented to encode the symbol 12. Once the symbol data has been decoded, it is de-obfuscated (if the original symbol data had been obfuscated as described above) by de-obfuscation function 37 which is illustrated in detail in FIG. 11. First, the clear checksum 64 is utilized as a key to decryption function 97 to decrypt the encrypted string 67. The decryption function 97 which was preloaded onto the user's computer means as part of an initialization process with the system is a corollary to the encryption function 66. By passing the checksum 64 in the clear and utilizing it as the key, it enables the user's computer means and document generation computing means to be synchronous with respect to the encryption methodology. After the decryption function 97 produces the clear data string comprising the original file location pointer 21, launch command 22, user demographics 23, source ID 24, key 25 and code type 26, then the checksum computing means 99 operates to compute a checksum of those fields. That computed checksum is then compared by comparison block 101 with the received clear checksum 64 that was decoded by the decoding process 36. If the comparison process 101 indicates that the computed checksum equals the received clear checksum, then go/no go signal 103 indicates that the data transmission and decryption process was successful. If, however, the checksums are not favorably compared, then the go/no go signal 103 will indicate an unsuccessful transmission and decryption process. If this is unsuccessful, then further processing is aborted.

Once the symbol data is de-obfuscated, it is then parsed by parsing block 39 in order to utilize the constituent fields as follows. The file location pointer 21 and source identifier string 24 are assembled into a register that will comprise the file transfer request. The file transfer request register is also loaded with a client version 72 taken from local memory 70 on the user's computer means. The user demographic string 23 is optionally fed into an encryption block 80 which is then used with encryption key 25 to encrypt that data and put the results as encrypted user information 82 into the file transfer request string 90. Optionally, the encryption function 80 may utilize certain local user data 74 that had been stored on the memory 70 of the user's computer means. This local user data may comprise sensitive information, such as the user's credit card number. Advantageously by encrypting this information the user will have a higher level of confidence that this sensitive information can be transmitted over the Internet for applications such as electronic commerce. Thus, the file transfer request register 90 will comprise the file location pointer 21, the client version 72, certain encrypted user information 82 and the source identifier 22.

The code type string 26 is compared by block 78 to the internally stored code type 76. If the comparison is unsuccessful, then further processing is aborted. This process is useful to enable certain versions of the client software to be distributed such as on a demonstration or trial basis, and this trial software will only work with certain documents generated by corresponding document generation software modules. Thus, a user having a trial version will not be able to fully utilize the system until it purchases by license or otherwise the production version. Utilization of this type of code type matching also enables the system vendor to control expired licenses, etc.

Once the file transfer request has been successfully assembled, it is then sent to the appropriate interface in order to obtain the requested file. In the preferred embodiment, the file transfer request will take the form of a uniform resource locator (URL) which will be sent to the Internet browser software 40 that is associated with the user's computer means.

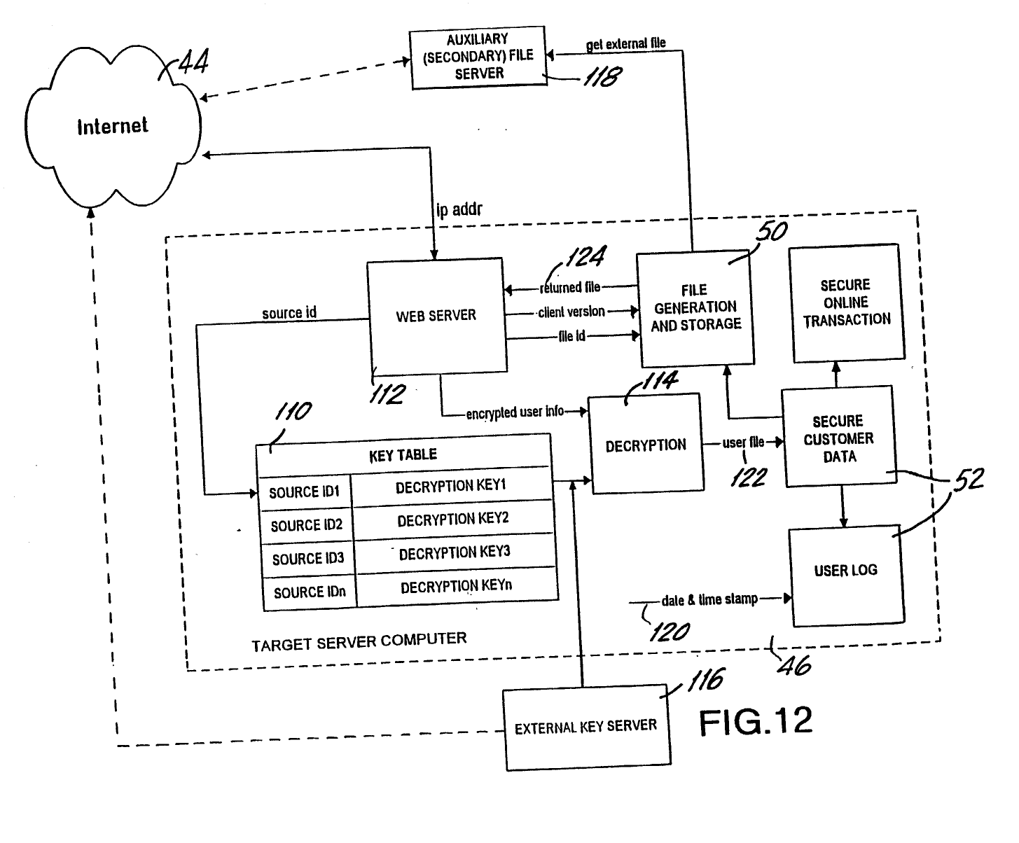

Referring to FIG. 12, the operation of the target server computer will now be described in detail. When the file transfer request 90 indicates that the file to be retrieved is located on an Internet file server, then the file location pointer 21 will comprise a URL, which comprises an IP address (Internet Protocol), as well as a file identifier. The IP address, as is well known in the art, is the address of the target server computer on the Internet. The Web server program 112 that is running on the target server computer 46 receives the URL over the Internet 44 and strips out certain parameters contained therein. The source identifier 24 is used to access a look up table 110 which comprises a plurality of source identifier strings and their associated decryption keys. This decryption key that is obtained from the key table 110 is then used by decryption block 114 to decrypt the encrypted user information received in the file transfer request. Decryption function 114 is corollary to the encryption function 80 performed at the user's computer means. Thus, the secure information transferred with the file transfer request is decrypted and user information file 122 may be stored in user log 52, along with the date and time stamp 120 to indicate when the particular request was received. This information is quite valuable to the vendor, since it enables it to determine the name and other useful information relating to users who have accessed its Web site. This information may also be utilized by file generation and storage means 50 to dynamically determine the file or files to be sent back to the user's computer means. For example, if the demographics data indicates that the user would prefer the file returned back in a language other than English, that file can be accessed or generated appropriately. Thus, in addition to retrieving a static page stored in the target server computer, the system of the present invention allows dynamic generation and return of computer files in accordance with user's preferences indicated in the transfer request. In addition, as described herein, if the user has allowed his credit card number to be encrypted and sent with the file transfer request, then the target server computer can decrypt the credit card number and utilize it to perform a secure online transaction.

In the alternative to having a file resident on the target server computer, it may be required for the target server computer to access an auxiliary file server 118 to get the external file and return it back to the user's computer means. The auxiliary file server 118 may be accessed directly, through a dial up modem connection, or through the Internet. In addition, an external key server 116 is accessible by the target server computer if it is desired by the system designer to keep the key table 110 remote from the target server computer, rather than local therein. By keeping a key table 110 at a central server location, the system provider can keep track of server requests to decrypt user information and charge a fee accordingly. Thus, a vendor utilizing this system may have the option of paying a per click fee to determine the user demographics of each user that accesses his server or may just provide files back to the user without obtaining that knowledge on a less costly basis.

When the file is returned back to the user's computer means through the Internet 44, it may be displayed in a manner well known in the art on a television screen via the Internet browser 40. Thus, the system of the present invention has provided an easy and error proof way for a user to obtain a computer file from an Internet server computer and displaying it to a television screen by simply scanning a code provided on an intelligent document and having the client automatically process the code, request the file wherein the file is then returned by the target server computer and displayed to the user.

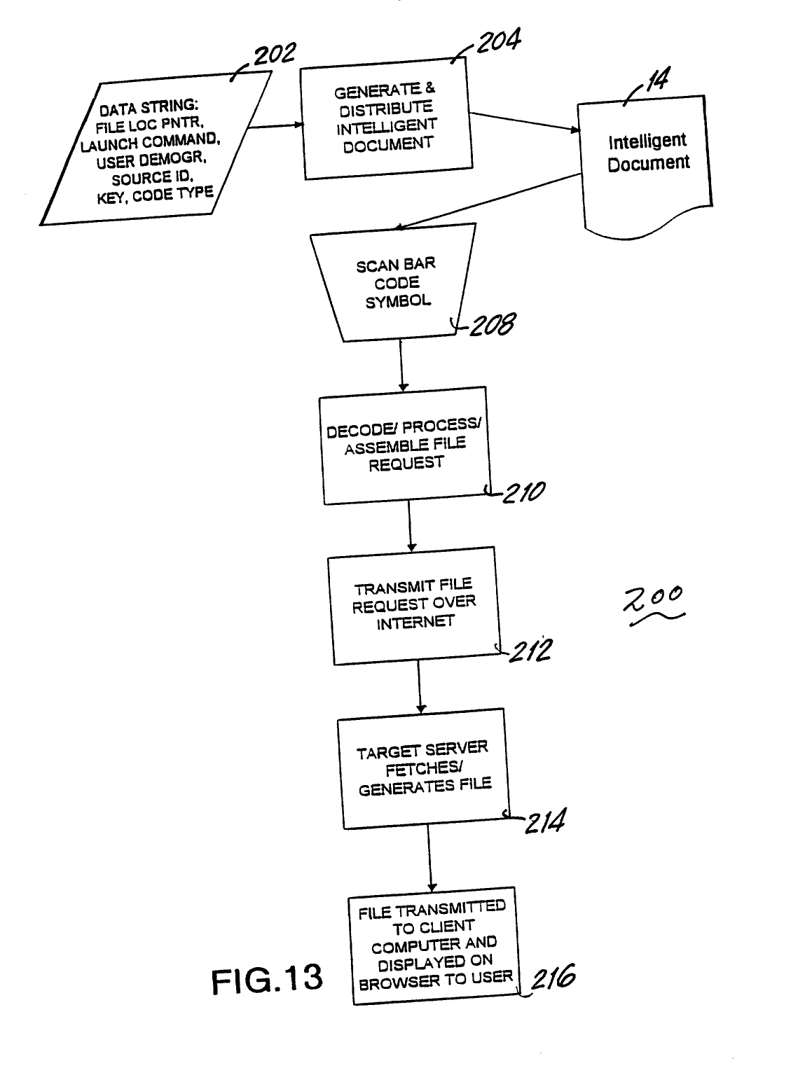

FIGS. 13 through 17 illustrate the flowcharts of the methodologies employed by the present invention. FIG. 13 is an overall flowchart wherein step 202 illustrates the data string comprising the file location pointer, launch command, user demographics, source identifier, key and code type. At block 204, the data string is utilized to generate an intelligent document 14 which is also distributed to the end users. At step 208, the bar code symbol is scanned, and at step 210 the data is decoded and processed and the file request is assembled. At step 212 the file request is transmitted over the Internet and at step 214 the target server retrieves and/or generates the computer file requested. Finally, at step 216 the file is transmitted to the user's computer means and displayed on the browser to the user.

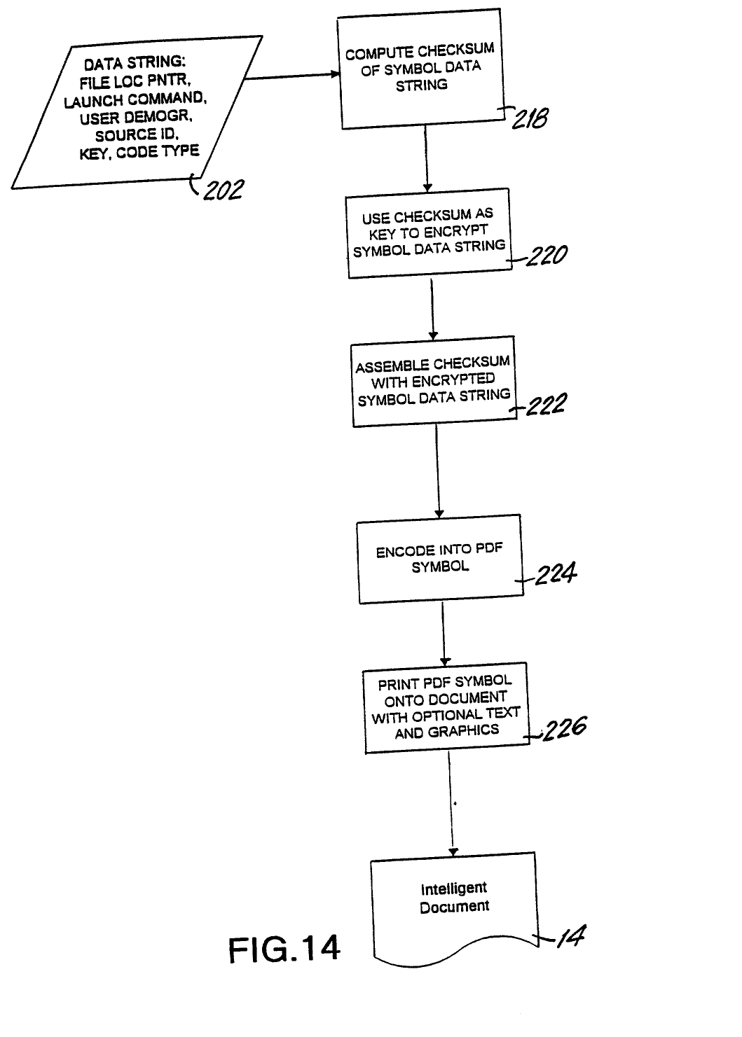

FIG. 14 is a more detailed flowchart of the document generation procedure. The data string at 202 is used to compute a checksum at step 218. At step 220, the checksum is used to encrypt the data string and at step 222 the checksum and encrypted data string are assembled. At step 224 the bar code symbol is encoded and at step 226 the bar code symbol is printed with optional text and graphics onto the intelligent document 14.

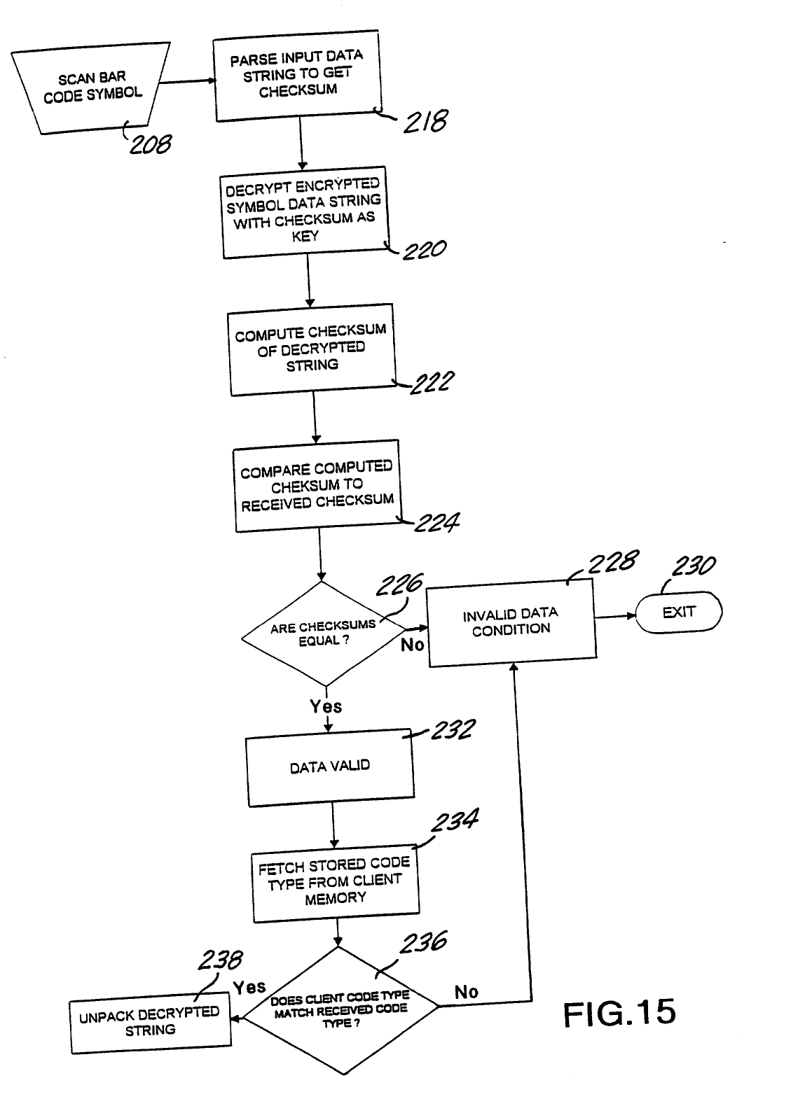

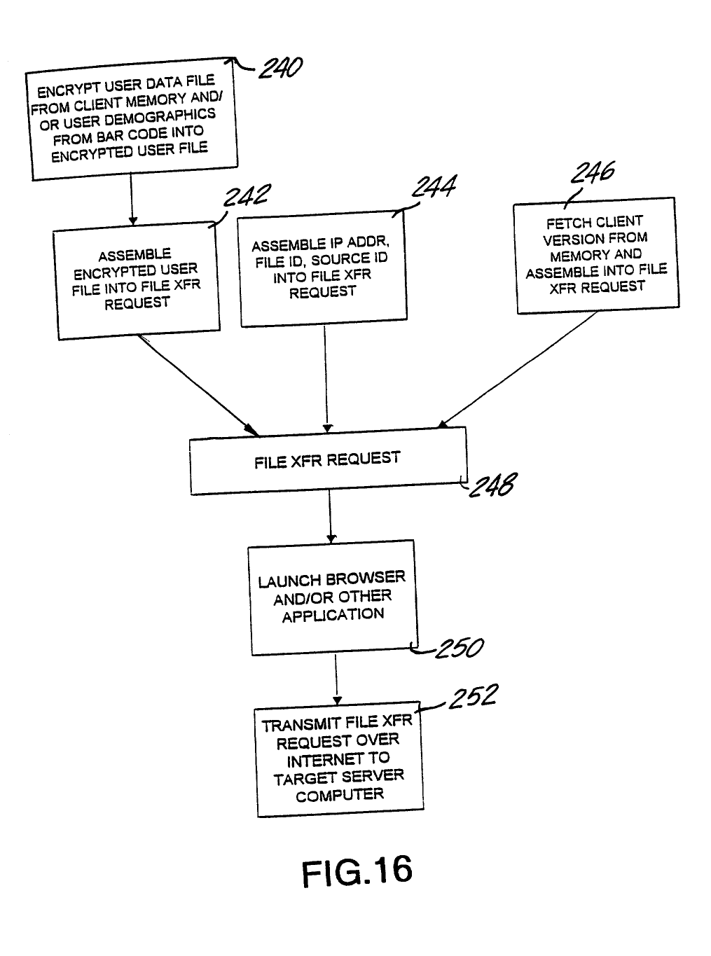

FIGS. 15 and 16 illustrate the detailed operation of the user's computer means. At step 208 in FIG. 15, the bar code symbol is scanned. At step 218 the input data string is parsed in order to derive the checksum and it is then decrypted with the checksum as the key. The decrypted string is used to computer a checksum and the received checksum is compared with the computed checksum. If the checksums are not equal, an invalid condition is declared and the process exits at step 230. If data is indicated valid at step 232, then the stored code type is retrieved from the client's memory at step 234. A comparison of the code type from the client memory with the received code type is compared at step 230. If an invalid data condition is indicated in this test, then the process exits at step 230 and if the code types match, then the process continues with an unpacking of the decrypted string at step 238.

Referring now to FIG. 16, the step 240 will encrypt the user data file from the client memory and optionally the user demographics received from the bar code to generate an encrypted user file. At step 242, the encrypted user file is assembled into the file transfer request 248. At step 244, the file location pointer comprising the IP address and file ID and the source ID are also assembled into the file transfer request and at step 246, the client version is retrieved from local memory and assembled into the file transfer request. At step 250, the browser is provided with the file transfer request and is optionally started by the launch command in the received string. At step 252, the file transfer request is transmitted to the target server, preferably in the preferred embodiment over the Internet in order to obtain the requested file.

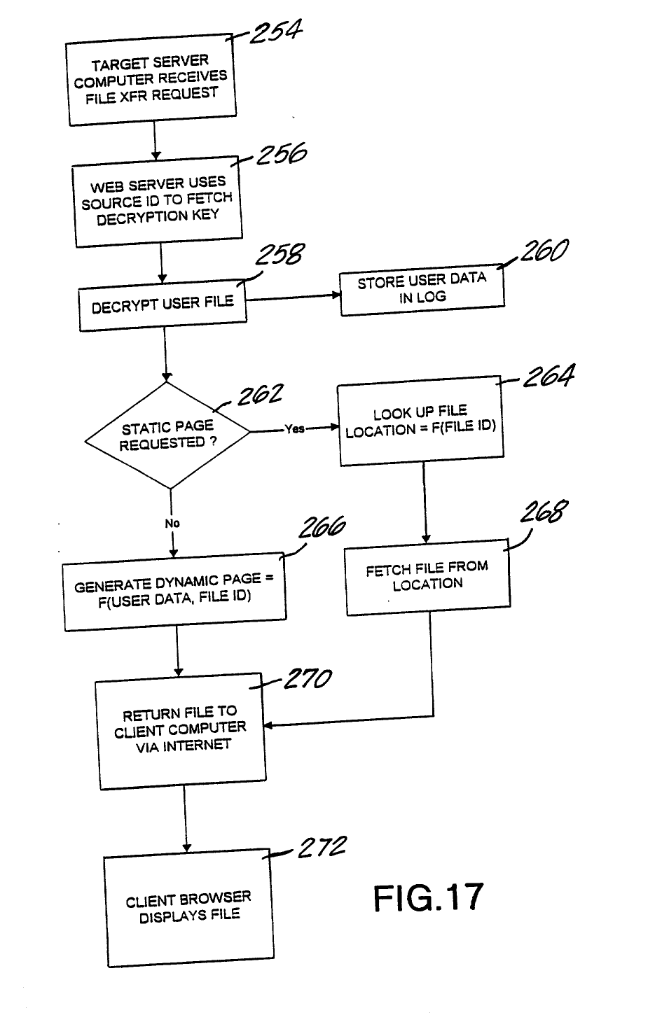

FIG. 17 illustrates the details of the methodologies employed by the target server computer. At step 254, the target server computer receives the file transfer request, and at step 256 the Web server program running on the target server computer uses the received source identifier to retrieve the associated decryption key which may be internal or externally located. At step 258, the user file is decrypted and the user data is stored in a log. If the static page has been requested by the user, then the file location is looked up as a function of the file identifier. At step 264, the file is retrieved from that location at step 268 and returned to the user's computer means via the Internet at step 270. If the static page was not requested at block 262, then a dynamic page is generated at step 266 which typically will be a function of the file identifier and/or the user data that had been received and decrypted. Again, the file is then returned to the user's computer means by the Internet and displayed on the user's browser at step 272.

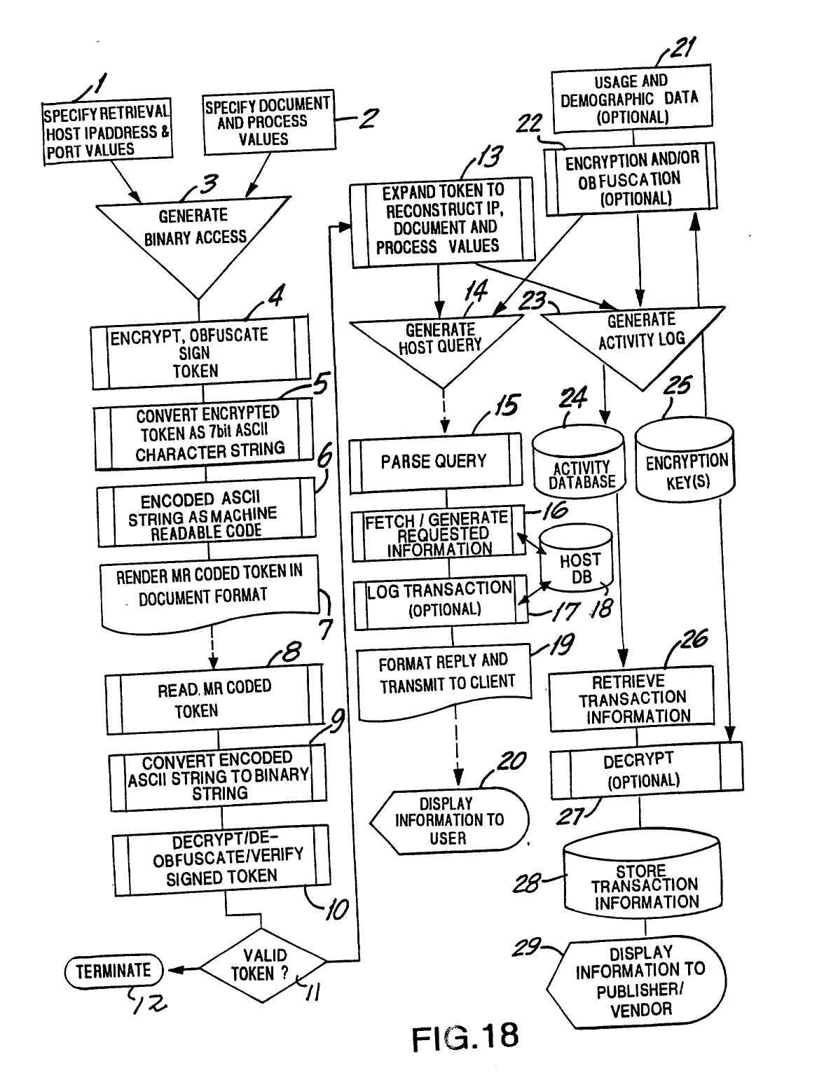

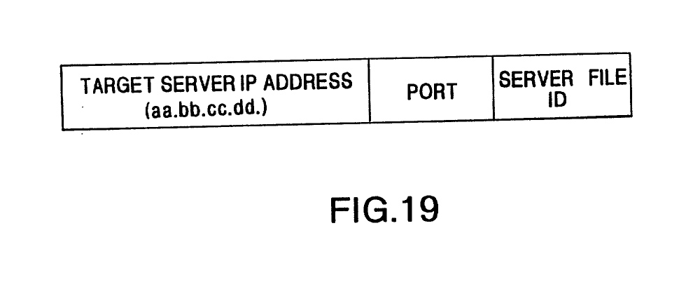

FIGS. 18 and 19 illustrate an alternative embodiment for encoding the Internet resource information into a linear (one-dimensional) bar code (an Internet hot-link) useful with the scanner-enhanced remote control unit of the present invention. Referring to FIG. 18, the document 14 embedded with an Internet hot-link bar-code 12 is generated by a document generation station as previously described.

The first step of the process takes place in the document generation station which controls the formatting of a code symbology such as a linear bar code to be printed onto the document 102. Prior to printing the bar code on the printed document 102, a host Internet Protocol (IP) address related to the target server 124 (the software which runs on the host computer that will be linked by scanning the document) is designated following standard TCP/IP syntax and a specific port is identified in step 1 of FIG. 18 if a default port for the host computer 120 has not been assigned. Similarly, process values representing publication information and predetermined responses to be returned by the target server 124 are defined in step 2. Both sets of information are expressed as binary strings in a predefined format in step 3 suitable for later parsing (e.g. data compression). An example of the binary string format is shown in FIG. 19.

Thus, the data to be included in the bar code 12 to be printed in the document 14, as shown in FIG. 19, includes the target server IP address in the aa.bb.cc.dd format, the (optional) port number, and data to indicate to the target server 124 which file should be sent back to the user's computer means.

Optionally, the server file ID field may be omitted, which will allow a smaller bar code symbol to be utilized. In this case, the target server computer will return a file found at a default location.

The resulting binary string or token is then encrypted, obfuscated (rendered obscure through a cipher or other non-encryption technique) and optionally signed with an encryption key in step 4 of FIG. 18. Alternatively, a hashing function could be performed upon the token and the result used as a digital signature appended to the printed document. The proper decryption, de-obfuscation or signature verification is subsequently performed by the user's computer decoding software to confirm that a licensed party generated the token. The token is then converted to an ASCII string in step 5 which is then converted to the standard syntax of a machine readable code in step 6 such as a linear barcode. The machine readable code is then rendered as a component of the printed document 102 in step 7. The printed document 102 is then ready for distribution and circulation.

The next step of the process takes place in the scanner-enhanced remote control unit which is adapted to scan the machine readable code as previously described. The user's computer means then processes the data from the scanner-enhanced remote control unit, and utilizes a stored decryption key to decrypt the data and verify its authenticity.

The decoded ASCII string is then converted to a corresponding binary equivalent in step 9 and is decrypted, de-obfuscated or the signature of the string or its hash is verified to confirm generation by an authorized or licensed party in step 10 which results in a token. If the token thus derived is not valid as determined in step 10 the retrieval process is terminated in step 12.

However, if the token is valid, it is expanded to reconstruct the IP address and port, document and process values in step 13 which are required to retrieve the indexed information from the target server. Usage and demographic information descriptive of the user's computer means may optionally be retrieved from memory and encrypted, obfuscated and signed in step 22 using a key 25 provided by a licensing party. The information resulting from step 21 is associated with the extracted IP address and port, document and process values from step 13, and then formatted using the syntax appropriate for an Internet communication session (e.g. WWW, html) thereby enabling a query to be asserted in step 14.

The query is transmitted onto the Internet by the user's computer means in conjunction with an Internet communication module such as a web browser. After being routed to the target host computer via standard Internet techniques, the query is unpacked and parsed by a communication module and server in step 15.

The target host computer then activates the server file which retrieves the requested information from storage or generate the requested information using programmed retrieval and formatting processes (e.g. CGI, RDBM) in step 16. In one embodiment static preformatted information (e.g. html), RDBMS elements and CGI and RDBMS scripts are stored on a local host database 18, however, such information could also be stored on an appropriate device accessible through structured data communications with the host including the client. These transactions can also be logged in step 17 for subsequent analysis concerning traffic and reconciliation with licensing charges. The retrieved or generated information is then formatted for transmission to the user computer means and transmitted using appropriate protocols (e.g. TCP/IP) in step 19. This information is then displayed to the user on the television screen and a screen dialog between the user and the information system proceeds. A portion of the content or format of the information presented to the user could be tailored to the individual user based on demographic and usage information conveyed in the original query.

Alternatively, the query information, particularly the demographic and usage information, may be stored in the form of an activity log in step 23 on a separate server or as an activity database 24 on the host computer. In the case where the activity database 24 is stored on the host computer the activity database 24 is encrypted and the information is retrieved for marketing or some other purpose in step 26, and decrypted in step 27 using the access key 25 which would generally be under the control of the licensing party and provided under commercial licensing terms. Following decryption this information could then be displayed or printed in step 29 or stored in step 28 for future analysis and use by the licensed publisher or vendor.

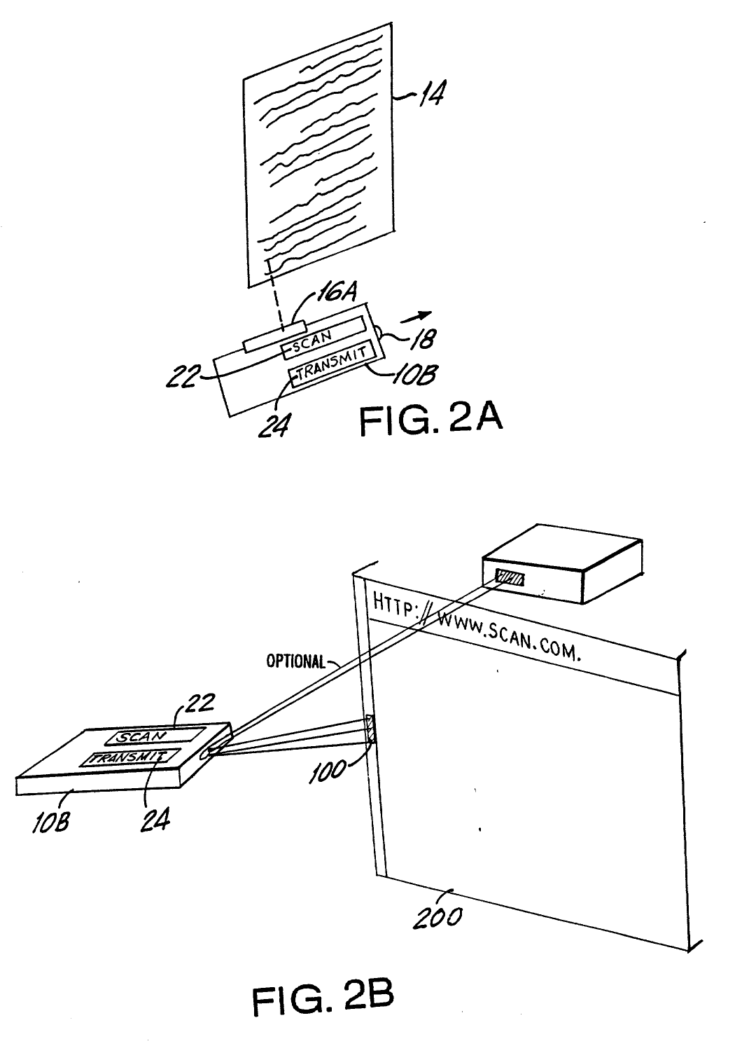

FIG. 2A illustrates a third embodiment of the scanner enhanced remote control unit 10B of the present invention which is shown scanning the printed document 14. The scanner enhanced remote control unit 10A comprises an optical character recognition scanning system 16A which is distinct from the transmission system 18 used to transmit information to a web ready television or television set-top conversion unit, personal computer 20b or any other system adapted for access to on-line resources (i.e., comprising a browser and a modem).

In order to access on-line resources with the third embodiment of the scanner enhanced remote control unit 10B, for which address and access information is contained on the printed document 14, a user will first depress a scan button 22 and then pass the optical character recognition scanning system 16A over the printed document 14. Alternatively, the optical recognition scanning system 16A may automatically be invoked without the need for depression of the scan button 22 whenever printed matter is encountered by the optical character recognition scanning system 16A, however, this may lead to false or incomplete scans.

Variants of the third embodiment are achieved by substitution of alternative technologies for the optical character recognition scanning system 16A. For instance, the optical character recognition scanning system 16A may be comprised of a two-dimensional array of charge coupled devices capable of scanning a wide variety of printed matter assuming the appropriate control and processing software is provided which is well known to one skilled in the art.

FIG. 2B illustrates transmission of the captured image data representative of the location of an on-line resource to a personal computer 20b. In this embodiment, the PC 20b is used, rather than a web-ready television set, for accessing the online resources while the user is located remotely from the PC 20b (i.e. across the room). Thus, the user can scan and access on-line resources without having to be physically in front of the PC (i.e., without being at the keyboard), and without having to manually type in the access (i.e. URL) information. Of course, the PC 20b must be adapted to receive remote control data to be utilized with the scanner-enhanced remote control unit of the present invention.

As shown in FIG. 2B, the PC may have associated therewith an IR sensor 100, which is adapted to receive scanned URL information and use it with a web browser to retrieve the associated file from the Internet. It is noted that the PC embodiment described herein is particularly well suited for use with the optical character recognition embodiment of this invention, wherein processing and memory requirements are relatively greater than in the bar code scanner embodiment.

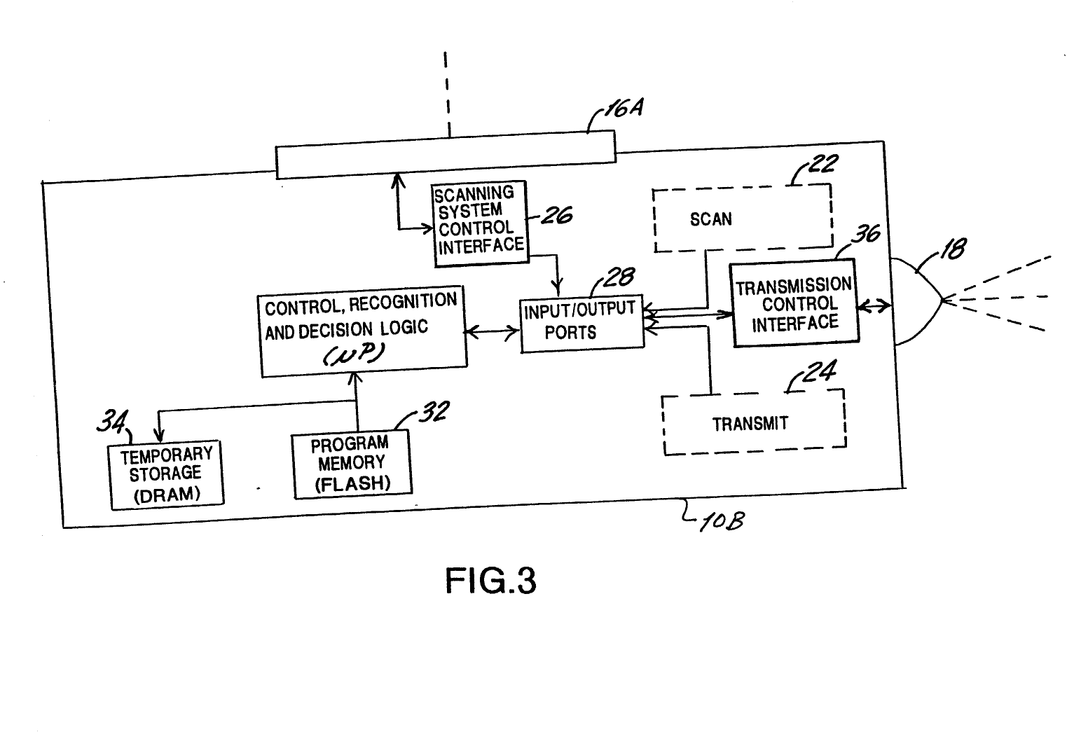

FIG. 3 illustrates a block diagram of the third embodiment of the scanner enhanced remote control unit 10B which is essentially applicable as well to the first and second embodiments and their variants except for the substitution of the optical character recognition scanning system 16A and its associated scanning system control interface 26 for the scanning system 16 of the first embodiment or the combination scanning and transmission system 18 of the second embodiment. The outputs of the scan button 22 and transmit button 24 (assuming that these buttons are present) are monitored at the input/output ports 28 which translate the depression of either button into a signal which is then passed to a control, recognition and decision logic block 30 via an interrupt, polling routine or alternative technique well known in the art. The input/output ports 28 are typically comprised of content addressable latches and registers. The control, recognition and decision logic block 30 is typically comprised of a microprocessor with additional programmable logic and support integrated circuits (e.g., interrupt controller, oscillator, buffers, etc.) and operates according to a predetermined program resident in program memory 32. The program memory 32 is typically comprised of some type of non-volatile memory storage integrated circuits such as FLASH memory, or electrically erasable prom (EEPROM). The control, recognition, and decision logic block 30 stores temporary variables along with a digitized version of the scanned image (whether it be scanned from machine readable symbol 12, as shown in FIG. 1A, or printed matter as shown in FIG. 2A) in a temporary storage area 34. The temporary storage area 34 typically comprises static ram (RAM), or dynamic ram (DRAM) if manufacturing costs are a significant consideration. The input/output ports 28 also provide data and control signal interfaces between the control, recognition and decision logic block 30, the scanning system control interface 26 and the transmission control interface 36.

In the first embodiment of the scanner enhanced remote control unit 10 the contents of the transmission control interface 36 and transmission system 18 are well known in the art as shown by the enormous quantity of units which are commercially available. Similarly typical components in the contents of the scanner system control interface 26 and scanning system 16A are well known in the art and described in U.S. Pat. Nos. 5,399,846 and 5,243,655 which are hereby incorporated by reference. In the second embodiment of the scanner enhanced remote control unit 10A the transmission control interface 36 and transmission system 18 would be required to perform both the scanning function and the transmission function. It is anticipated that either one or a combination of charge coupled devices (CCD), radiation emitting diodes (e.g., laser, infrared or some other band of the spectrum), or another suitable technique well known to those skilled in the art would be used with control and interface circuitry adapted to modulate between the two functions. The following references provide information on charge coupled devices and are hereby incorporated by reference:

1. G. F. Amelio, Charge-coupled Devices Scientific American, 230(2);22-31, February 1974.

2. F. Bower, CCD Fundamentals Fairchild Camera and Instrument Corp., February 1978.

Machine readable symbol 12 may be rendered in any of a variety of bar code formats. A bar code symbol is a pattern comprised of a series of bars of various widths and spaced apart from one another by spaces of various widths, the bars and spaces comprising different light reflective properties. The bars represent strings of binary ones and the spaces represent strings of binary zeros. Generally, the bars and spaces can be no smaller than a specified minimum width which is defined as a module or unit. The bars and spaces are multiples of this module size or width.

Bar code symbols are typically scanned by optical techniques, such as one-dimensional or two-dimensional scanning laser beams, wands or Charge Coupled Devices (CCD), and the resulting electrical signals are decoded into data representative of the symbol for further processing. It is anticipated that such techniques would be used in the scanning systems 16 and 16A as well as the combination scanning and transmission system 18A of the present invention. One and two-dimensional bar codes of the prior art are illustrated in FIGS. 4A and 4B, respectively, and are disclosed in greater detail in U.S. Pat. Nos. 5,243,655; 5,471,533; and 5,399,846, which are hereby incorporated by reference.

Optical Character Recognition (OCR) is the technology of using machines to automatically identify human-readable symbols, most often alpha-numeric characters, and then to express identifiers in machine readable codes. The operation of transforming numbers and letters into a form adapted for electronic data processing is an essential method of introducing information, such as address and access to online resources by the optical character recognition scanning system 16A of the present invention, into computing systems.

In general an OCR system comprises the following blocks: input, transport, scan, preprocess, feature extraction and classification logic, and output. The transport function as applied to the optical character recognition scanning system 16A of the present invention comprises the passing of the scanner enhanced remote control unit 10B over the printed document 14 comprising printed matter relevant to on-line resources. The transport function may also comprise the depression of the scan button 22 in order to invoke scanning unless this function is automatically invoked.

The scanning function converts reflected or transmitted light into an electric signal which is then digitized by an analog-to-digital converter (ADC). Although less complex, transmitted light scanning requires the additional step of making a transparency of every image to be scanned.

Optical scanners either employ a flying spot or a flying aperture principle. In the first instance a spot of light sequentially illuminates successive portions of the image to be scanned, and all the reflected or transmitted light is collected by a detector. In flying aperture devices the entire document is flooded with light, but light is collected sequentially spot by spot from the illuminated image. An example is Vidicon® scanners in which a document is flooded with light from an ordinary light source, and the reflected or transmitted light impinges upon the photoconductive target of the Vidicon. The image on the surface causes a variations in the local charge concentration, which is converted into a video signal by sequentially scanning the photoconductive surface with an electron beam. Mechanical scanners, television cameras, CRT flying-spot scanners, solid-state linear and two-dimensional array scanners, and electrooptical scanners which use a laser as the source of illumination are the techniques primarily used in commercial applications.

In solid-state scanners the image is scanned by electronically switching between adjacent areas scanned by different elements in an array. Flying spot devices use linear on-dimensional or two-dimensional light-emitting diode arrays. Flying aperture devices use arrays of photodiodes or phototransistors. The most commonly used scan pattern is a raster scan in which the flying spot or flying aperture sequentially scans the character area by using a sawtooth pattern. Due to the use of microprocessors in the scanner enhanced remote control units 10, 10A, and 10B of the present invention, complete programming of the scanner is feasible which makes it possible to rescan rejected characters, and to scan blank areas at low resolution in order to increase throughput and perform additional preprocessing functions in parallel.

The preprocessing function typically comprises line finding, character location and isolation, normalization and centering, and other function that may be needed prior to feature extraction and classification. The nature and degree of preprocessing required depends on whether the printed document 14 to be scanned is comprised of stylized fonts, typescript, typeset text, or hand printed characters.

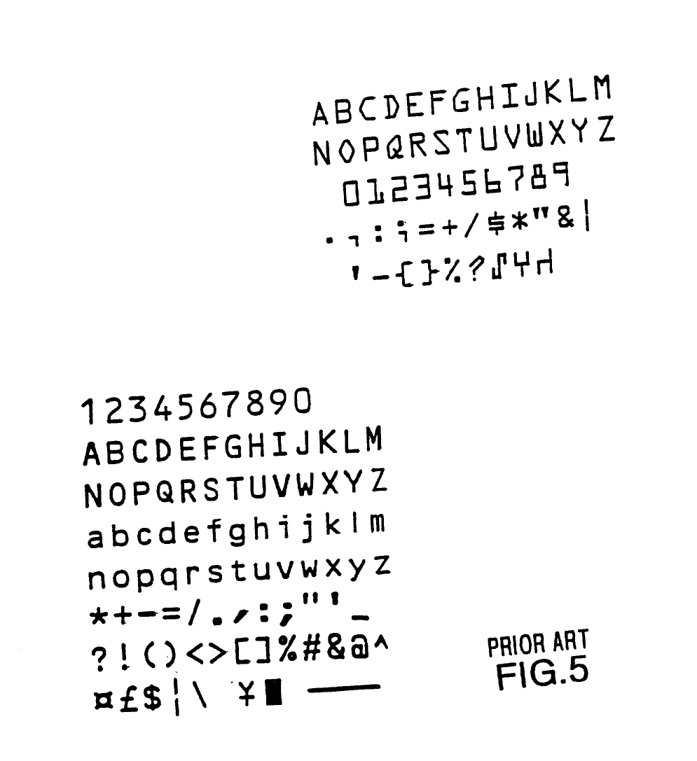

Stylized font characters of the prior art, such as those illustrated in FIG. 5, have well-defined and controlled formats and spacing. Documents using stylized font characters generally also have special symbols to guide the scanner to each field of information. Special ink, invisible to the scanner, is used to print material not to be scanned.

Software capable of performing line finding algorithms compensate for baseline drift in the lines of the printed document 14. Where characters are not uniformly spaced or in which easily detectable boundaries do not occur where expected, character segmentation may involve a scanning aperture that is smaller than that used for the subsequent classification function. A number of heuristic algorithms are available and well known in the art to separate touching characters, eliminate noise such as isolated dots, and smooth out gaps or breaks in line segments.

The amount of rotation and skew correction, character segmentation, size normalization, centering, and noise elimination available on individual characters prior to classification determines how sophisticated the feature extraction and algorithms must be for a given application. Many commercial applications simply employ a template matching technique which provides adequate performance only if variation of the above types have been essentially eliminated.

Recognition is typically achieved by extracting distinctive features and using them in a decision logic to classify the characters. Decision logics are designed by using statistics of features obtained from sets of learning samples representative of the intended applications.

Optical correlation, resistor summing networks, and parallel digital logic circuits represent some of the ways in which character and feature templates and weighted masks have been implemented in hardware. Centering of the character being scanned within a recognition window, referred to as registration, may be done by shifting the digitized character through a discrete number of successive positions in a one or two dimensional shift register. Approaches to segmenting a line of print into individual characters include comparing successive vertical scans to give an explicit segmentation of the entire line or alternatively looking for peaks in the output of the classifier to implicitly segment each character. For a more complete discussion of the contents typically found in the scanning system control interface 26 and optical character recognition scanning system 16A well known to those skilled in the art, the following references are hereby incorporated by reference:

1. N. Ahuja and B. J. Schacter, Pattern Models, 1983.

2. K. S. Fu, Syntactic Pattern Recognition and Applications, 1982.

The following represents a discussion of those concepts relating to the Internet and other on-line resources required for an understanding of the present invention. The World Wide Web is a distributed hypermedia repository of information that is accessed with an interactive browser. A browser displays a page of information and allows the user to move to another page by making a selection using a pointing device such as a mouse or by transmitting the scanned image retained in any of the embodiments of the scanner enhanced remote control unit 10, 10A, or 10B of the present invention.

Web documents are written in the Hyper-Text Markup Language (HTML). In addition to text, a document contains tags that specify document layout and formatting. Some tags cause an immediate change, while others are used in pairs to apply an action to multiple items. Because an HTML document uses a textual representation, images are not included directly in a document. Instead, a tag is placed in the document to specify the place at which an image should be inserted and the source of the image.

The anchor tag is used to specify those items in an HTML document which correspond to an external reference. When a browser displays the document, the browser marks the reference to obtain a new document. Because an anchor can include arbitrary items, a selection can correspond to a picture or an icon as easily as to text.

External references are given in the form of a Universal Resource Locator (URL). Such a URL would be contained in the machine readable symbol 12 shown in FIGS. 1A and 1B or the printed document of FIG. 2A as address and access information to on-line resources. A browser within the web-ready television, television set-top conversion unit or personal computer 20b would extract from the URL the protocol used to access the item, the name of the computer on which the item resides, and the name of the item. A URL that begins with http:// specifies that the browser should use the Hyper-Text Transport Protocol (HTTP) to access the item; the browser can also use other services such as File Transfer Protocol (FTP).

The browser consists of a controller, one or more clients used to access documents, and one or more interpreters used to display documents. Each browser must contain an HTML client to retrieve Web pages and an HTML interpreter to display them. In addition, the browser can include clients that permit access to services such as file transfer or electronic mail, and interpreters that display documents that use representations other than HTML.

To make document retrieval efficient, the browser uses caching. The browser places a copy of each document or image that the user views on the local disk. Whenever the document is needed, the browser checks that cache before requesting the document from the server on the network. Most browsers allow users to control the length of time documents are kept in the cache as well as other control parameters.

When a browser interacts with a web server, the two programs follow the HTTP. In principle, HTTP is straightforward: it allows the browser to request specific items, which the server then returns. To ensure that browsers and servers can interoperate unambiguously, HTTP defines the exact format of requests sent from the browser to the server as well as the format of replies that the server returns.

Browsers have a more complex structure than Web servers. The server performs a straightforward task repeatedly: the server waits for the browser to open a connection and request specific pages. The server then sends a copy of the requested item, closes the connection, and waits for the next connection. The browser handles most of the details of document access and display. Consequently, the browser contains several large software components that work together to provide the illusion of a seamless service.

Conceptually, the browser comprises a set of clients, a set of interpreters, and a controller that manages them. A controller forms the central piece of the browser. It interprets inputs from the scanner enhanced remote control unit 10, 10A or 10B, and calls other components to perform operations specified by the user. For example, when the URL is transmitted by the scanner enhanced remote control unit 10, 10A, or 10B, the controller calls a client to retrieve the requested document from the remote server on which it resides, and the interpreter to display the document to the user.

Each browser must contain an HTML interpreter to display documents. Other interpreters are optional. Input to the HTML interpreter consists of a document that conforms to the HTML syntax. The output of the HTML interpreter consists of a formatted version of the document on the display of the web-ready television, television set-top conversion unit or personal computer 20b. The HTML interpreter handles layout details by translating HTML specifications into commands that are appropriate for the various display. For example, if it encounters a heading tag in the document, the HTML interpreter changes the size of the text used to display the heading. Similarly, if it encounters a break tag, the HTML interpreter begins a new line of output.

A more complete discussion of the Internet and computer network theory is provided in the following references hereby incorporated by reference:

1. D. Comer, The Internet (1995).

2. D. Comer, Computer Networks and Internets (1997).

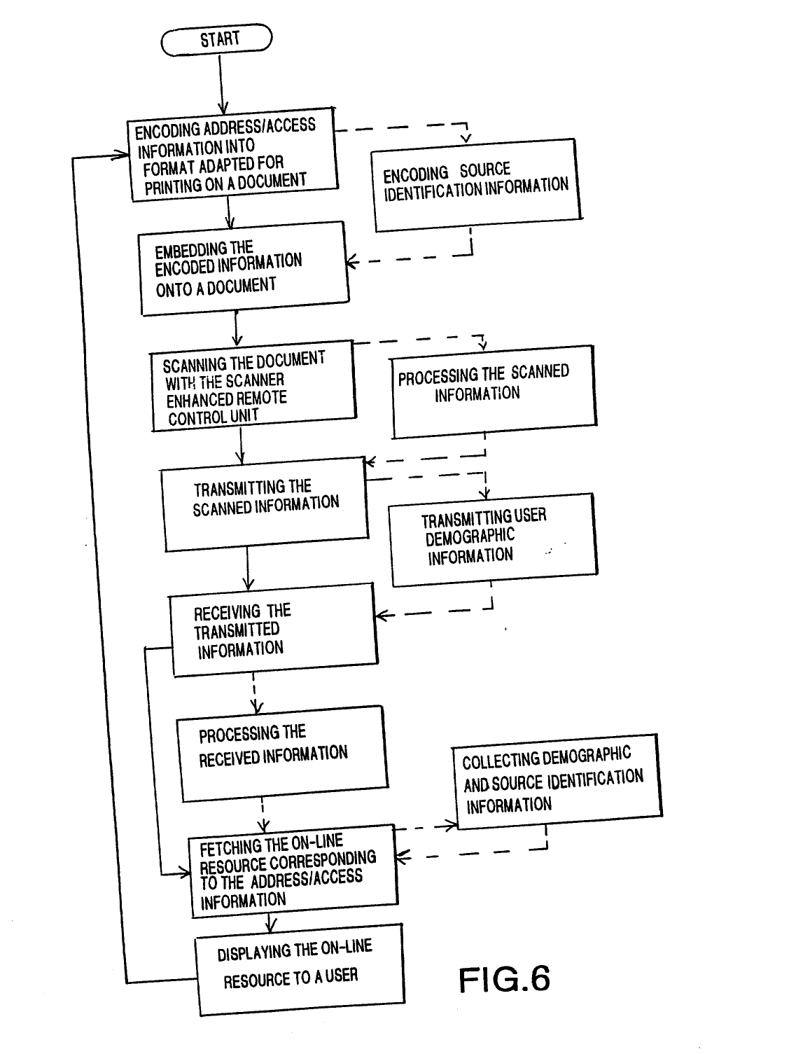

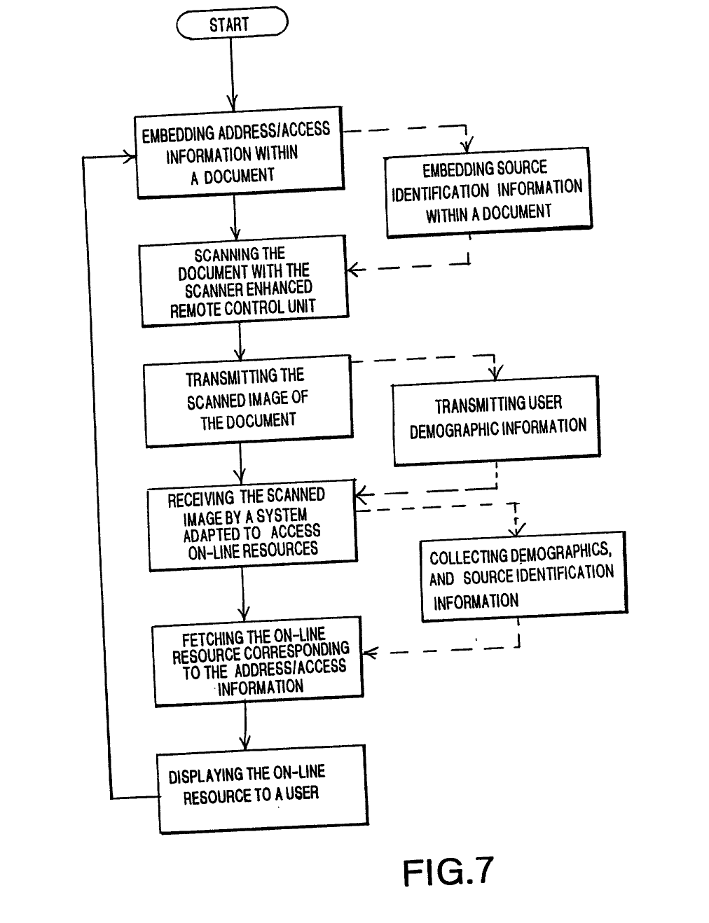

The method of linking to on-line resources with a scanner enhanced remote control unit is illustrated in FIG. 6. The method comprises the steps of encoding address and access information to on-line resources, and optionally source identification information regarding the document the address information is embedded on into a format suitable to printing onto a document. The encoded information is embedded onto a document which is then scanned with the scanner enhanced remote control unit and optionally processed within the scanner enhanced remote control unit. The scanner enhanced remote control unit then transmits the scanned information with optional demographic information relating and the transmitted information is received. The received information is then optionally processed within the receiving system (typically a system adapted to access on-line resources). User demographic information and the source identification information is optionally collected for subsequent analysis and the specific on-line resource corresponding to the address and access information encoded on the document is then retrieved and displayed to the user.

Potential applications for a direct and efficient link between printed media and on-line resources are potentially limitless. Broadcast schedules (e.g., TV Guide®) could be published with address and access information to online resources relevant to a particular program. Such schedules could then be scanned and used to link with the online resources. For instance;

1. sporting events could be listed with sites comprising player statistics, commercial sale of team related goods, books, video recordings of the event being watched, and advance ticket sales;

2. travel shows could be listed with sites providing further detail regarding the region being discussed, commercial sale of travel arrangements, maps, books, guides, suitable clothing, and luggage;

3. educational shows could be listed with sites providing simultaneous access to on-line primary, high school, and college equivalency courses, tutoring in particular subjects, commercial purchase of books and compact discs, examinations taken on-line with instant results (each of which having particular applicability to the handicapped, temporarily injured, gifted or those with special needs;

4. prime time programs could be listed with sites providing schedules of guest appearances of actors and actresses, and the commercial purchase of books and tapes written by or about the program or players;

5. telethons, and publicly supported channels could be listed with sites providing an option to simultaneously contribute via secure electronic currency;

6. soap operas could be listed with sites providing access to prior episodes in summary or detail, background of characters and actors playing each character, and contact information regarding fan clubs;

7. game shows could be listed with sites providing simultaneous participation in on-line versions of the same game being conducted via broadcast or cable transmission;

8. nature shows could be listed with sites providing an option to simultaneously contribute to wildlife/restoration funds using secure electronic currency, and information regarding conservation of and travel to the regions being filmed;

9. movies cold be listed with sites providing the ability to purchase relevant books and videos, participate in trivia quizzes, and information regarding special appearances of actors, and fan clubs; and

10. talk shows could be listed with sites providing the ability to reply and participate in discussions with the audience.

While various changes and modifications may be made in the detailed construction, it is understood that such changes or modifications will be within the spirit and scope of the present invention, as it is defined by the appended claims.

1. A method of providing remote access to on-line resources comprising the steps of:
encoding address information adapted to link to an on-line resource into a format adapted for printing on a document;
embedding said encoded information onto said document;
scanning said document with a scanner enhanced remote control unit comprising a scanning system adapted to obtain an image of said embedded information and a transmission system adapted to transmit information to a system adapted to access said on-line resource;
transmitting said scanned information;
receiving said transmitted information by said system adapted to access said on-line resource;
retrieving said on-line resource corresponding to said address information; and
displaying said on-line resource to a user.

2. The method of claim 1, further comprising processing said scanned image in said scanner enhanced remote control unit prior to said step of transmitting.

3. The method of claim 1, further comprising processing said received information in said system adapted to link to said on-line resource subsequent to said step of transmitting.

4. The method of claim 1, wherein said format further comprises linear, one-dimensional bar code.

5. The method of claim 4, wherein said scanning system further comprises a one-dimensional laser scanner.

6. The method of claim 4, wherein said scanning system further comprises a two-dimensional laser scanner.

7. The method of claim 4, wherein said scanning system further comprises an LED wand scanner.

8. The method of claim 4, wherein said scanning system further comprises a linear, one-dimensional array of charge coupled devices.

9. The method of claim 4, wherein said scanning system further comprises a two-dimensional array of charge coupled devices.

10. The method of claim 1, wherein said format further comprises two-dimensional bar code.

11. The method of claim 10, wherein said scanning system further comprises a two-dimensional laser scanner.

12. The method of claim 10, wherein said scanning system further comprises a linear, one-dimensional array of charge coupled devices.

13. The method of claim 10, wherein said scanning system further comprises a two-dimensional array of charge coupled devices.

14. The method of claim 1, wherein said format further comprises printed matter, said scanning system comprising a two-dimensional array of charge coupled devices, said step of scanning being performed by optical character recognition techniques.

15. The method of claim 1, wherein said system adapted to access said on-line resource further comprises a web-ready television.

16. The method of claim 1, wherein said system adapted to access said on-line resource further comprises a television set-top conversion unit adapted to allow an associated television to display Internet resources.

17. The method of claim 1, wherein said system adapted to access said on-line resource further comprises a personal computer

18. The method of claim 1, further comprising encoding identification information regarding said document into said format, embedding said information regarding said document onto said document, and transmitting said information regarding said document with demographic information regarding said user.

19. The method of claim 7, further comprising receiving said identification information regarding said document and said demographic information, thereby enabling an on-line provider and an on-line server to gain access to said demographic information and said identification information.

20. The method of claim 1, wherein said step of scanning said document further comprises scanning automatically in response to said scanner enhanced remote control unit being passed across said document.

21. The method of claim 1, wherein said step of scanning said document further comprises scanning in response to depression of a scan button on said scanner enhanced remote control unit while said scanner enhanced remote control unit is passed over said document.

22. The method of claim 1, wherein said step of transmitting said scanned information further comprises transmitting said scanned information automatically subsequent to scanning.

23. The method of claim 1, wherein said step of transmitting said scanned information further comprises transmitting said scanned information in response to depression of a transmit button on said scanner enhanced remote control unit.

24. The method of claim 1, wherein said transmitted information represents substantially all of that portion of said document scanned.

25. The method of claim 1, wherein said transmitted information represents less than substantially all of that portion of said document scanned.

26. The method of claim 1, wherein said scanning system and said transmission system share light sources.

27. An apparatus for providing remote access to online resources comprising, which comprises:
means for encoding address and access information adapted to link to said on-line resource into a format adapted for printing on a document;
means for embedding said encoded information onto said document;
a scanner enhanced remote control unit comprising a means for scanning adapted to scan and obtain an image of said embedded information and means for transmitting adapted to transmit information to a system adapted to access said on-line resource;
means for receiving said transmitted information by said system adapted to access said on-line resource;
means for retrieving said on-line resource corresponding to said address and access information; and
means for displaying said on-line resource to a user.

28. The apparatus of claim 27, further comprising means for processing said scanned image in said scanner enhanced remote control unit prior to application of said means for transmitting.

29. The apparatus of claim 27, further comprising means for processing said received information in said system adapted to link to said on-line resource subsequent to application of said means for transmitting.

30. The apparatus of claim 27, wherein said format further comprises linear, one-dimensional bar code.

31. The apparatus of claim 30, wherein said scanning system further comprises a one-dimensional laser scanner.

32. The apparatus of claim 30, wherein said scanning system further comprises a two-dimensional laser scanner.

33. The apparatus of claim 30, wherein said scanning system further comprises an LED wand scanner.

34. The apparatus of claim 30, wherein said scanning system further comprises a linear, one-dimensional array of charge coupled devices.

35. The apparatus of claim 30, wherein said scanning system further comprises a two-dimensional array of charge coupled devices.

36. The apparatus of claim 27, wherein said format further comprises two-dimensional bar code.

37. The apparatus of claim 36, wherein said scanning system further comprises a two-dimensional laser scanner.

38. The apparatus of claim 36, wherein said scanning system further comprises a linear, one-dimensional array of charge coupled devices.

39. The apparatus of claim 36, wherein said scanning system further comprises a two-dimensional array of charge coupled devices.

40. The apparatus of claim 27, wherein said format further comprises printed matter, said scanning system comprising a two-dimensional array of charge coupled devices, which scans by optical character recognition techniques.

41. The apparatus of claim 27, wherein said system adapted to access said on-line resource further comprises a web-ready television.

42. The apparatus of claim 27, wherein said system adapted to access said on-line resource further comprises a television set-top conversion unit.

43. The apparatus of claim 27, wherein said system adapted to access said on-line resource further comprises a personal computer

44. The apparatus of claim 27, further comprising means for encoding identification information regarding said document into said format, means for embedding said information regarding said document onto said document, and means for transmitting said information regarding said document with demographic information regarding said user.

45. The apparatus of claim 27, further comprising means for receiving said identification information regarding said document and said demographic information, thereby enabling an on-line provider and an on-line server to gain access to said demographic information and said identification information.

46. The apparatus of claim 27, wherein said means for scanning said document automatically scans said document in response to said scanner enhanced remote control unit being passed across said document.

47. The apparatus of claim 27, wherein said means for scanning said document scans in response to depression of a scan button on said scanner enhanced remote control unit while said scanner enhanced remote control unit is passed over said document.

48. The apparatus of claim 27, wherein said means for transmitting said scanned information automatically transmits said scanned information subsequent to scanning.

49. The apparatus of claim 27, wherein said means for transmitting said scanned information transmits said scanned information in response to depression of a transmit button on said scanner enhanced remote control unit.

50. The apparatus of claim 27, wherein said transmitted information represents substantially all of that portion of said document scanned.

51. The apparatus of claim 27, wherein said transmitted information represents less than substantially all of that portion of said document scanned.

52. The apparatus of claim 27, wherein said means for scanning and said means for transmitting share light sources.

53. An apparatus comprising:
a housing;
optical scanning means within said housing for scanning a machine-readable symbol printed on a document and producing an electrical signal indicative of said machine-readable signal, said machine-readable symbol being encoded with data representative of a location of a data file to be accessed by a computer means associated with said apparatus;
means within said housing for processing said electrical signal to produce address information useful in accessing said data file;
means within said housing for transmitting said address information to a remotely located computer means; and
means within said housing for remotely controlling a television means associated with said computer means.
